(19) United States
(12) Patent Application Publication
(10) Pub. No.: US 2024/0367605 A1
(43) Pub. Date: Nov. 7, 2024

(54) MOVABLE PARTITION FOR VEHICLE

(71) Applicants: Hyundai Motor Company, Seoul (KR); Kia Corporation, Seoul (KR); SEOYON E-HWA CO., LTD, Anyang-Si (KR)

(72) Inventors: Ji Ah Kim, Seoul (KR); Ji Seob Park, Incheon (KR); Jin Ho Hwang, Cheonan-si (KR); Jae Moon Jeong, Namyangju-si (KR)

(21) Appl. No.: 18/531,811

(22) Filed: Dec. 7, 2023

(30) Foreign Application Priority Data
May 4, 2023 (KR) 10-2023-0058068

(51) Int. Cl. B60R 21/02

(52) U.S. Cl. CPC B60R 21/026

(57) ABSTRACT

A movable partition comprises a housing located inside a vehicle, a first partition deployable through an opening located in at least one side of the housing, a second partition located in the housing and configured to have a predetermined angle with respect to the first partition, and a fixing unit located in the housing and configured to be fastened to at least a portion of the first partition. The first partition comprises at least one plate extending and/or extendable outward from the housing.

### CROSS REFERENCE TO RELATED APPLICATION

The present application claims priority to Korean Patent Application No. 10-2023-0058068, filed May 4, 2023, the entire contents of which are incorporated herein for all purposes by this reference.

### FIELD

The present disclosure relates to a movable partition. More particularly, the present disclosure relates to a movable partition that comprises a housing movable along an upper surface of a floor of a vehicle, thus allowing a partition to be selectively deployed at different positions in a vehicle interior space.

### DISCUSSION OF THE BACKGROUND

Generally, a partition for a vehicle may comprise a blocking plate that blocks and/or partitions a space in the vehicle. For example, the partition may be a partition wall configured to dividing the space in the vehicle.

A partition for a vehicle may be installed for the purpose of blocking and/or partitioning/dividing to provide protection of a driver and/or police, etc. (e.g., in a taxi or police car). The partition may be able to open and/or comprise means to allow ventilation and/or communication while maintaining a blocking strength (e.g., for the sake of safety).

The partition for the vehicle is problematic in that the partition remains closed and/or static. It may be difficult to check a driver's condition and/or communicate with a driver. The needs of a passenger may not be delivered. Moreover, the partition is fixedly installed, which may be problematic in that it is difficult to move the partition (e.g., in response to a user's request and/or with varying needs/uses of the vehicle).

For example, vehicles may be used for multiple purposes and/or used by and/or to transport multiple users (e.g., for commuting, camping/traveling, VIP protection, delivery of cargo, etc.). The partition may not be well suited to the multiple uses/users.

### SUMMARY

The following summary presents a simplified summary of certain features. The summary is not an extensive overview and is not intended to identify key or critical elements.

Systems, apparatuses, and methods are described for a movable partition. A movable partition may comprise a housing located inside a vehicle; a partition unit comprising a plurality of partitions configured to be in the housing or to extend from the housing; and a fixing unit located in the housing and configured to be fastened to at least a portion of the partition unit so as to restrict a movement of the partition unit. At least one partition forming the partition unit may comprises at least one plate extendable outward from the housing.

These and other features and advantages are described in greater detail below.

### BRIEF DESCRIPTION OF THE DRAWINGS

The above and other objectives, features, and other advantages of the present disclosure will be more clearly understood from the following detailed description, taken conjointly with the accompanying drawings, in which:

FIG. 1 is a diagram illustrating a movable partition located in a vehicle according to an example of the present disclosure.

FIG. 2 is a perspective view illustrating the movable partition according to an example of the present disclosure.

FIG. 3A is a diagram illustrating a first partition of the movable partition located in the vehicle according to an example of the present disclosure.

FIG. 3B is a top view illustrating the first partition of the movable partition located in the vehicle according to an example of the present disclosure.

FIG. 4A is a diagram illustrating a first partition of a movable partition located in a vehicle according to another example of the present disclosure.

FIG. 4B is a top view illustrating the first partition of the movable partition located in the vehicle according to another example of the present disclosure.

FIG. 5A is a side view illustrating the first partition of the movable partition located in the vehicle according to an example of the present disclosure.

FIG. 5B is a side view illustrating a fixed state of the first partition of the movable partition located in the vehicle according to an example of the present disclosure.

FIG. 6A is a perspective view illustrating a second partition of the movable partition located in the vehicle according to an example of the present disclosure.

FIG. 6B is a side view illustrating the second partition of the movable partition located in the vehicle according to an example of the present disclosure.

### DETAILED DESCRIPTION

Hereafter, examples of the present disclosure will be described in detail with reference to the accompanying drawings. The present disclosure may take many different forms and should not be construed as being limited to only the examples set forth herein. These examples are provided to help those skilled in the art more thoroughly and completely understand the present disclosure.

In addition, terms such as “part”, “unit,” and “module” used herein mean a unit that processes at least one function or operation, which may be implemented by hardware, software, or a combination of hardware and software.

The terminology used herein is for the purpose of describing particular examples only and is not intended to be limiting. In the present disclosure, the singular forms are intended to comprise the plural forms as well, unless the context clearly indicates otherwise.

It will be understood that, although the terms “first”, “second”, etc. may be used herein to describe various elements, these elements should not be limited by these terms. These terms are only used to distinguish one element from another element, and do not refer to an order.

Hereinafter, examples of the present disclosure will be described in detail with reference to the accompanying drawings. In the present disclosure, the same reference numerals are used to designate the same or similar elements throughout the drawings, and repeated descriptions of the same elements will be omitted.

The present disclosure is directed to a movable partition, which comprises a housing 10 movable along the inside of an indoor floor 400 of a vehicle. The housing 10 may be configured such that a partition unit 30 provided in the housing 10 is deployed (e.g., extended and/or retracted). The partition unit 30 of the present disclosure may comprise and/or be configured to form a plurality of partitions. The partition unit 30 may be configured to allow a first partition 100 and a second partition 200 to be selectively deployed.

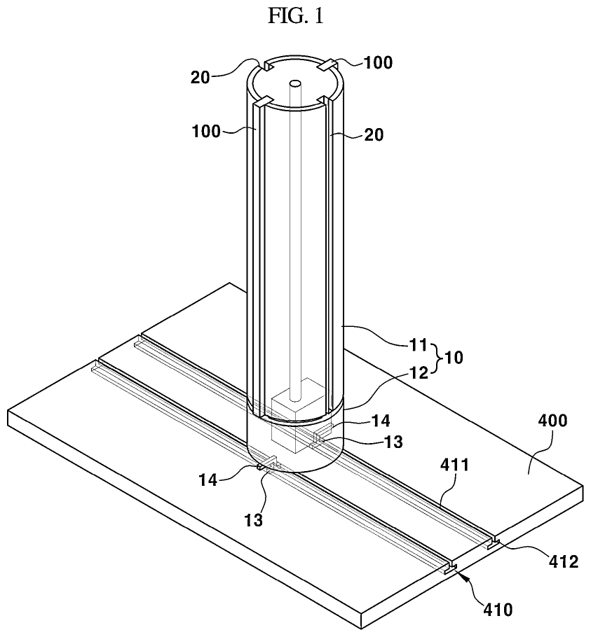

FIG. 1 is a diagram illustrating a movable partition located on the floor 400 (e.g., of a vehicle) according to an example of the present disclosure.

The housing 10 may be located on the floor 400, and may be moved along a transfer unit 410 that may be located in the floor 400. The transfer unit 410 may be fastened and/or configured to be fastened to a lower housing 12, and may be embedded in and/or formed into the floor 400 (e.g., so as not to be exposed to the outside and/or above the floor). The lower housing 12 may be configured to move along a sliding rail 411 having an open slit. The housing 10 may comprise the lower housing 12 fastened and/or configured to be fastened to the transfer unit 410, and an upper housing 11 fastened and/or connected to the lower housing 12 so as to be rotatable relative to the lower housing 12. The upper housing 11 may be fixedly fastened to a driving shaft protruding from an upper surface of the lower housing 12, and may be configured to rotate integrally with the driving shaft, which may be rotated if power is received from a wire portion 412 of the sliding rail 411 located on a rear surface of the lower housing 12. The partition unit 30 may be fastened to the upper housing 11, and the partition unit 30 may be configured to extend from the upper housing 11.

The transfer unit 410 comprises the sliding rail 411 buried in the floor 400, and a T-shaped bracket 13 located on the rear surface of the lower housing 12 may be inserted into the sliding rail 411. The T-shaped brackets 13 extend along the rear surface of the lower housing 12 to protrude to both sides. The upper ends of the T-shaped brackets 13 protruding to both sides are fastened to the lower housing 12 while having the same direction as the longitudinal direction of the sliding rail 411. After the T-shaped brackets 13 are fastened to the inside of the transfer unit 410, the upper ends of the T-shaped brackets 13 protruding to both sides are rotated along the inner sides of the sliding rails 411, and the upper end may be configured to engage with the inside of the open slit of the sliding rail 411. A lever portion 14, configured such that the protruding upper end of the T-shaped bracket 13 may be rotated, may be located on a side of the lower housing 12. Thus, the T-shaped bracket 13 may be inserted and/or insertable through the slit into the sliding rail 411. If the lever portion 14 rotates, the upper end of the T-shaped bracket 13 inserted into the sliding rail 411 may be configured to rotate inside the sliding rail 411. Therefore, the lower housing 12 may be selectively moved along the sliding rail 411 without being dislodged from the sliding rail 411 of the transfer unit 410.

In an example of the present disclosure, the wire portion 412 configured to be energized by a battery of the vehicle may be comprised inside the sliding rail 411. The wire portion 412 may be configured to contact the protruding upper end of the T-shaped bracket 13 and apply power into the housing 10. Thus, the wire portion may be configured to apply power to a display unit 500 provided on the first partition 100 or the second partition 200. Alternatively, power may be applied to at least one lamp among the housing 10, the first partition 100, and the second partition 200.

Further, a driving force may be applied via a motor located in the lower housing 12 to the upper housing 11 that may be rotated relative to the lower housing 12. Power may be applied through the wire portion 412 from the vehicle battery to the motor, and the upper housing 11 may be rotated by driving the motor to which the power is applied. As will be discussed, a direction in which the first partition 100 or the second partition 200 is deployed may be adjusted by rotating the upper housing 11.

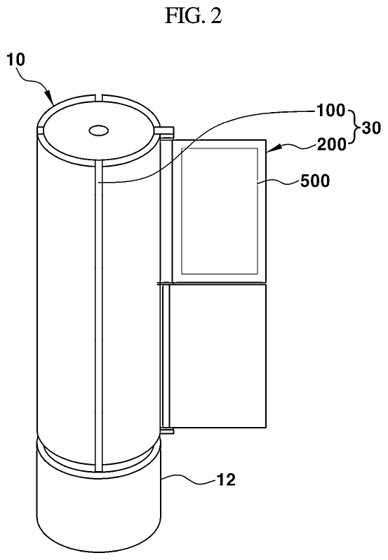

FIG. 2 illustrates the configuration of the partition unit 30 located inside the housing 10, according to an example of the present disclosure.

The partition unit 30 may be comprised inside and/or extending and/or extendable from the upper housing 11. The partition unit 30 may comprise the first partitions 100 and the second partitions 200. The first partitions 100 are configured to be deployed to the outside of the housing 10 through openings that are provided on both sides of the housing 10 to be symmetrical with respect to each other. The second partition 200 may be located in the opening of the housing 10 to have a predetermined angle with each first partition 100. The first partitions 100 are located on both sides of the housing 10 to have the angle of 180 degrees with respect to the housing 10, while each second partition 200 may be located on the corresponding side of the housing 10 to have the angle of 90 degrees with each of the first partitions 100.

The first partition 100 may be in the form of and/or comprise a multi-stage plate held and/or positioned on the inside of the housing 10. The first partition may comprise a handle portion 120 on the outermost plate. Thus, the first partition 100 may be deployed by applying tension to (e.g., pulling and/or rotating) the handle portion 120, and neighboring plates deployed in response to the rotation of the handle portion 120 may be fixed.

According to an example of the present disclosure, a first plate 101 and a second plate 102 forming the first partition 100 are comprised. The first plate 101 may be fastened to the housing 10 so as to be deployed alongside the housing 10. The second plate 102 may be fastened to the first plate 101 so as to be deployed with the first plate 101 (e.g., integrally with the first plate 101) if the first plate 101 is deployed. Moreover, the second plate 102 may comprise a first end that is farther away from the housing 10 with respect to the first plate 101, and the handle portion 120 may be located at one end that is far away from the housing. Further, the second plate 102 comprises a roller portion 130, and the roller portion 130 moves along a recess located in the first plate 101. The roller portion 130 of the second plate 102 may be configured to be deployed from the first plate 101, and one end of the handle portion 120 may be located inside the roller portion 130. If tension is applied to the handle portion 120 in a direction away from the housing 10, the roller portion 130 located in the second plate 102 may be deployed in a direction away from the housing 10 along the recess of the first plate 101.

Moreover, a collet 140 may be comprised between the handle portion 120 and the roller portion 130, the collet 140 applies tension to the outside of the roller portion 130 in response to the rotation of the handle portion 120, and the roller portion 130 comes into contact with the side surface of the recess of the first plate 101 to fix the second plate 102 to the first plate 101. If the handle portion 120 inserted into the roller portion 130 is rotated by a set angle, a section may widen. Thus, if the handle portion 120 rotates, the collet 140 may be pressed to limit the driving of the roller portion 130.

A third plate 103 located in the first plate 101 to be deployed to the bottom of the first plate 101, and/or a fourth plate 104 located in the second plate 102 to be deployed to the bottom of the second plate 102 may be comprised. The third plate 103 and/or the fourth plate 104 may be manually and/or automatically deployed. The third and fourth plates may be deployed downward from the first plate 101 and/or the second plate 102 (e.g., after the first plate 101 and/or the second plate 102 are deployed).

The second partition 200 may be formed in a roll blinder, and may be movable along a groove 20 that is formed in a height direction of the housing 10. The second partition may comprise two or more roll blinders that are movable, respectively, along at least two grooves 20. A fastening portion 210 (e.g., a fastener) may be provided on the deployed end of the second partition 200. The fastening portion 210 may be fixed to a predetermined area located inside the vehicle. Therefore, in a state where the second partition 200 is deployed, the fastening portion 210 may be fixedly located inside the vehicle. The fastening portion 210 may be inserted and fixed in the area defined inside the vehicle, or may be configured to perform magnetic fastening. Moreover, the upper housing 11 may be rotated to fix the second partition 200 comprising the fastening portion 210 to a set position.

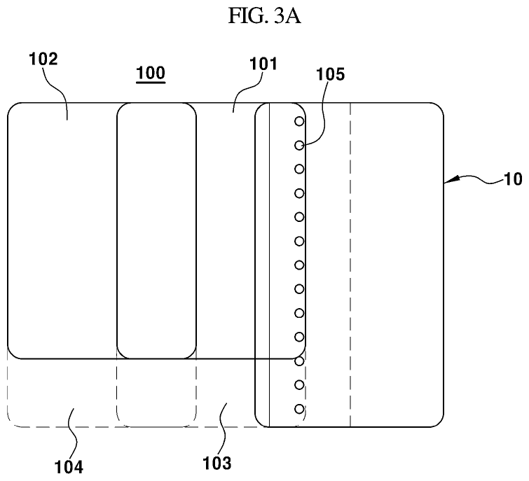

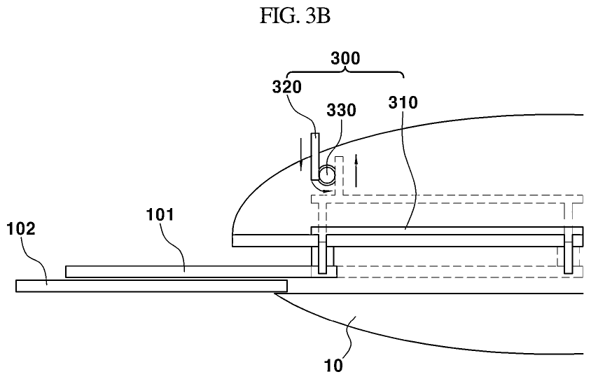

FIG. 3A is a diagram illustrating the first to fourth plates 101 to 104 forming the first partition 100 according to an example of the present disclosure.

As shown in the drawing, the first partition 100 comprises the first plate 101 that may be moved integrally with a rail portion 110 of the housing 10, and the second plate 102 that may be additionally deployed along the recess of the first plate 101. The second plate 102 may comprises the roller portion 130 that may be inserted and/or insertable into the recess defined in the first plate 101. The roller portion 130 may move and/or be movable along the recess of the first plate 101 if the second plate 102 is deployed.

The first plate 101 may comprise at least one rail portion 110 on a surface facing the housing 10. A protrusion located in the housing 10 may engage (be engageable with) with the rail portion 110. Moreover, if the first plate 101 is deployed, the rail portion 110 may move integrally with the first plate 101 along the protrusion. According to an example of the present disclosure, the rail portion 110 may be located at each of upper and lower ends of the first plate 101, and the protrusion formed in a longitudinal direction where the first partition 100 is deployed may be comprised at a position corresponding to the rail portion 110. Therefore, the first plate 101 may move integrally with the rail portion 110 in the longitudinal direction where the protrusion is formed.

The third plate 103 and the fourth plate 104 may be comprised in the lower end of the first plate 101 and/or the second plate 102. The third plate may be additionally deployed in the height direction along the first plate 101 if the first plate 101 is deployed, and the fourth plate 104 may be additionally deployed in the height direction along the second plate 102 if the second plate 102 is deployed.

The movable partition may comprise a fixing unit 300 configured to limit the movement of at least one plate that is deployed with respect to the housing 10. The fixing unit 300 may be fastened to a fixing hole 105 formed in the first plate 101 so as to limit the movement of the first plate 101.

Moreover, as shown in FIG. 3B, the fixing unit 300 comprises a fixing portion 310 that may be located in the housing 10 to be fastened to the fixing hole 105 of the first plate 101, an actuating pin 320 that may be located outside the housing 10 and may be actuated to allow the fixing portion 310 to be inserted into the fixing hole 105, and a connecting portion 330 that may be configured to reverse an actuating direction so that the fixing portion 310 may be removed from the fixing hole 105 in response to the pressing of the actuating pin 320.

Therefore, in a state where the first partition 100 is deployed, the fixing portion 310 of the fixing unit 300 may be inserted into and/or detached from the fixing hole 105 (e.g., based on or in response to the operation of the actuating pin 320). According to an example, the actuating pin 320 may be provided outside the housing 10, and the fixing portion 310 may be configured to be inserted into the fixing hole 105 of each of the first partitions 100 located on both sides if two first partitions 100 located on both sides of the housing 10 are deployed. That is, the fixing portion 310 may comprise two projections fastened to one actuating pin 320.

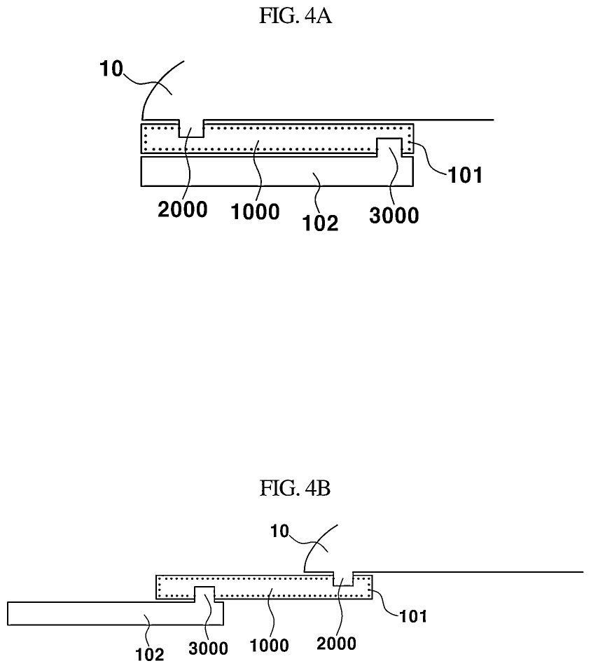

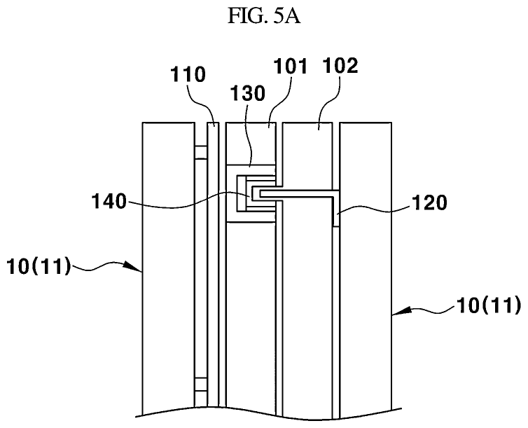

FIGS. 4A and 4B are sectional views illustrating the deployed structure of the first partition 100 according to another example of the present disclosure.

As shown in the drawings, the movable partition comprises a rotary member 1000 surrounding the inner surface of the first plate 101 and rotatable. A first link member 2000 (e.g., a first link) located inside the housing 10 to face the first plate 101 may be configured to fastened to the rotary member 1000. A second link member 3000 (e.g., a second link) may be located in the second plate 102 to face the first plate 101 and fasten to the rotary member 1000. The rotary member 1000 may receive a driving force from a driving portion located in the first plate 101, and may be rotated along/on the inner surface of the first plate 101. The rotary member 1000 may be rotated so that the first plate 101 moves in a direction deployed with respect to the first link member 2000 located in the housing 10. Simultaneously, the second link member 3000 located in the second plate 102 may be moved in the same direction as the rotary member 1000, and the second plate 102 may be moved in a direction deployed from the first plate 101.

That is, the first link member 2000 and the second link member 3000 fixed to the rotary member 1000 that is rotated along the inner surface of the first plate 101 may be moved and/or movable (e.g., integrally) in the rotating direction of the rotary member 1000. If the first plate 101 is deployed with respect to the housing 10, the second plate 102 may be deployed with respect to the first plate 101 (e.g., with the first plate 101).

Therefore, in the illustrated example, it is possible to determine the deployment amount of the first and second plates 101 and 102 according to the rotating amount of the rotary member 1000 to which the driving force is applied.

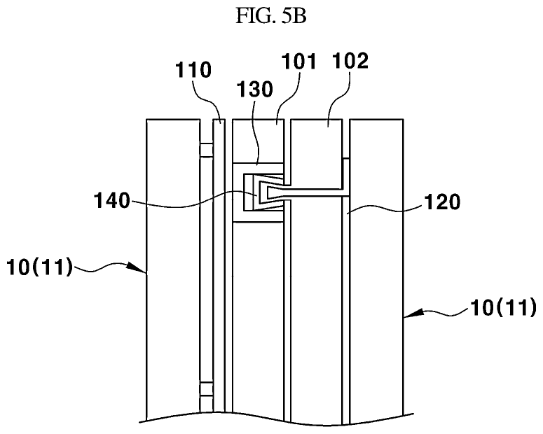

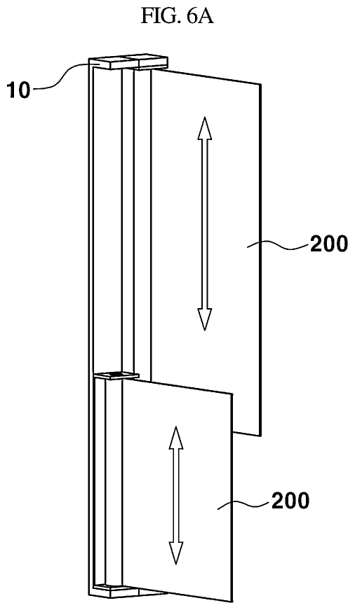

FIGS. 5A to 5B show a fastening relationship between the first plate 101 and the second plate 102 and a driving relationship between the housing 10 and the first partition 100.

FIG. 5A is a side view illustrating a state where the first plate 101 and the second plate 102 as the first partition 100 are held on the inner surface of the housing 10.

If the rail portion 110 of the first plate 101 engages with the protrusion of the housing 10 and a force is applied in a direction in which the first partition 100 is deployed, the rail portion 110 of the first plate 101 moves in the longitudinal direction along the protrusion of the housing 10.

Moreover, the roller portion 130 of the second plate 102 is located inside the recess defined in the first plate 101 to be moved along the recess. The roller portion 130 may be configured such that one end of the handle portion 120 located at the outermost portion of the second plate 102 is located in the central portion of the roller portion 130. Further, the handle portion 120 may be configured to be rotatable in the central portion of the roller portion 130.

The collet 140 may be comprised between the handle portion 120 and the roller portion 130, and the collet 140 may be configured to come into contact with the roller portion 130 in response to the rotation of the handle portion 120. If the roller portion 130 is pressed by the outer surface of the collet 140, the roller portion may be fixed in the recess of the first plate 101, thus limiting the movement of the roller portion. If the handle portion 120 inserted into the central portion of the roller portion 130 is rotated to limit the movement of the second plate 102, the inner circumference of the collet 140 may be pressed outward, and the outer circumference of the collet 140 may be configured to contact and/or contact the inner circumference of the roller portion 130. By the rotation, one end of the handle portion 120 may be configured to have a different section.

FIG. 5B is a sectional view illustrating a configuration in which the roller portion 130 contacts the inner surface of the recess if the handle portion 120 is rotated. That is, the handle portion 120 may be rotated downward at 180 degrees so as to limit the movement of the second plate 102 with respect to the first plate 101, and the collet 140 located between the roller portion 130 and one end of the handle portion 120 may be opened in the height direction to respond to a change in section of one end of the handle portion 120. Thus, the inner circumference of the roller portion 130 may be pressed in a radial direction to contact the inner surface of the recess located in the first plate 101. Thereby, the second plate 102 may be fixed to the first plate 101, thus restricting the independent deployment of the second plate 102.

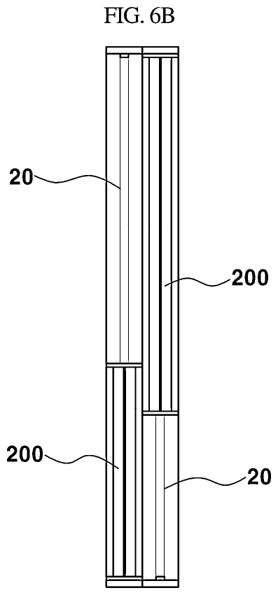

FIG. 6A illustrates the housing 10 comprising two second partitions 200 according to an example of the present disclosure, and FIG. 6B is a side view illustrating the housing 10 comprising the second partition 200.

The second partition 200 of the present disclosure is located in the housing 10 to have a predetermined angle with the first partition 100. Two openings may comprise comprised to have the angle of 90 degrees with respect to the opening of the housing 10 through which the first partition 100 is deployed. The first partition 100 and the second partition 200 may be deployed to have the angular interval of 90 degrees.

Moreover, the second partition 200 may be formed in a roll blinder, and comprise two roll blinders that overlap each other in the height direction. Further, the second partition 200 formed in the roll blinder may move along the groove 20 in the height direction of the housing 10.

That is, the second partition 200 comprises at least two roll blinders in the height direction, and the second partition 200 composed of the roll blinder may be fastened to the groove 20 located in the housing 10 to be selectively moved in the height direction.

An end of the second partition 200 in the deployment direction comprises the fastening portion 210. The fastening portion 210 may be fixedly fastened to a predetermined area located inside the vehicle. The fastening portion 210 may comprise a component that performs magnetic fastening, or may be fastened to a slot to perform interference fitting.

In addition, the upper housing 11 may be configured to be rotatable with respect to the lower housing 12, thus setting a direction in which the second partition 200 may be deployed, and the second partition 200 deployed in the set direction may be set in position thereof to face the predetermined area inside the vehicle.

The present disclosure addresses problems occurring in the related art by, e.g., providing a movable partition that may move along a floor of a vehicle.

Further, the present disclosure is to provide a movable partition that may be drawn out from a housing in various directions.

Furthermore, the present disclosure is to provide a movable partition that may be further deployed in a height direction through a partition deployed to one side.

A movable partition for accomplishing the objectives of the present disclosure described above comprises the following configuration.

The present disclosure provides a movable partition comprising a housing located inside a vehicle, a partition unit comprising a plurality of partitions located in the housing, and a fixing unit located in the housing to be fastened to at least a portion of the partition unit, and at least one partition forming the partition unit may comprise at least one plate extending outward from the housing.

The partition unit may comprise a first partition deployed through an opening located in at least one side located on the housing, and a second partition located in the housing to have a predetermined angle with the first partition, and the first partition may comprise one or more plates.

The first partition may be located on either side of the housing, and may comprise a first plate configured such that at least a portion thereof is located inside the housing to face the fixing unit, and a second plate extending along the first plate in a direction away from the housing.

The movable partition may further comprise a third plate located such that at least a portion thereof overlaps with the first plate and additionally deployed in a height direction along the first plate, and a fourth plate located such that at least a portion thereof overlaps with the second plate and additionally deployed in the height direction along the second plate.

The movable partition may further comprise a fixing hole located in the first plate and fastened to the fixing unit.

The fixing unit may comprise a fixing portion inserted into the fixing hole to fix the first plate, an actuating pin located outside the housing and applying tension to detach the fixing portion from the fixing hole, and a connecting portion moving the fixing portion in a direction opposite to an actuating direction of the actuating pin.

The fixing portion may be configured to simultaneously fix the first partitions located on both sides of the housing.

The movable partition may further comprise a rail portion located in the first partition and moving integrally with the first partition along a protrusion located in the housing, and the rail portion may move along the protrusion so that the first partition is deployed from the housing.

The movable partition may further comprise a rotary member rotated along an inside of the first plate, a first link member located inside the housing and fastened to the rotary member, and a second link member located in the second plate facing the first plate and fastened to the rotary member, and the rotary member may be rotated so that the first plate is moved in a direction in which it is deployed with respect to the first link member, and the second link member is moved in a direction in which it is deployed with respect to the first plate.

The second partition may be formed in at least one roll blinder deployed with respect to the housing to have a predetermined angle with the first partition.

At least two roll blinders may be located in upper and lower ends of the housing in a height direction thereof.

The movable partition may further comprise a fastening portion fixing an end of the second partition to a vehicle body.

The second partition formed in the roll blinder may be moved vertically along a groove located in the housing.

The housing may comprise an upper housing comprising the partition unit, and a lower housing located in a lower end of the upper housing to move along a transfer unit provided on a floor, and the upper housing may be configured to be rotatable with respect to the lower housing.

The transfer unit may comprise a sliding rail buried in the floor, a T-shaped bracket located on a rear surface of the lower housing to be inserted into the sliding rail, and a lever portion configured to rotatably insert the T-shaped bracket into the sliding rail.

The movable partition may further comprise a wire portion located inside the sliding rail and configured to conduct electricity with the T-shaped bracket.

The movable partition may further comprise a handle portion located at an outermost portion of the second plate, and a roller portion located in the second plate and moving along the first plate, and the handle portion may be located inside the roller portion and be configured to press an inside of the roller portion in response to rotation of the handle portion.

The first plate may comprise a collet located in the roller portion facing the second plate, and one end of the handle portion may be located inside the collet so that the collet is opened in response to the rotation of the handle portion.

At least one of the first partition and the second partition may comprise a display unit.

The present disclosure can obtain the following effects by combining and using the above-described example and the following configuration.

The present disclosure is advantageous in that it provides a movable partition that can move to various positions, thus affording user convenience.

Further, the present disclosure is advantageous in that it provides a multi-directional partition structure located in one housing, thus increasing space efficiency.

Moreover, the present disclosure is advantageous in that a partition that can be additionally deployed in a height direction, thus securing personal privacy.

The above description is illustrative of the present disclosure. Further, the foregoing is intended to illustrate examples of the present disclosure, and the present disclosure can be used in various other combinations, modifications and environments. That is, changes or modifications are possible within the scope of the disclosure, equivalents thereof and/or the scope of skill or knowledge in the art. The example illustrates the best mode for implementing the technical spirit of the present disclosure, and various changes required in specific application fields and uses of the present disclosure are also possible. Therefore, the above description is not intended to limit the present disclosure to the disclosed example. Also, the appended claims should be construed to cover other examples as well.

What is claimed is:

1. A movable partition comprising:
a housing located inside a vehicle;
a partition unit comprising a plurality of partitions configured to be in the housing or to extend from the housing; and
a fixing unit located in the housing and configured to be fastened to at least a portion of the partition unit so as to restrict a movement of the partition unit,
wherein at least one partition forming the partition unit comprises at least one plate extendable outward from the housing.

2. The movable partition of claim 1, wherein the partition unit comprises:
a first partition, comprising one or more plates, deployable through an opening in at least one side of the housing; and
a second partition extendable from the housing at a predetermined angle relative to the first partition.

3. The movable partition of claim 2, wherein the first partition is located to extend from a side of the housing and comprises:
a first plate, at least a portion of which is located inside the housing and faces the fixing unit; and
a second plate extending along the first plate in a direction away from the housing.

4. The movable partition of claim 3, further comprising:
a third plate, at least a portion of which overlaps with the first plate, that is extendable in a height direction along the first plate; and
a fourth plate, at least a portion of which overlaps with the second plate, and that is extendable in the height direction along the second plate.

5. The movable partition of claim 3, further comprising:
a fixing hole in the first plate, configured to fasten the fixing unit to the first plate.

6. The movable partition of claim 5, wherein the fixing unit comprises:
a fixing portion configured to be inserted into the fixing hole to fix the first plate;
an actuating pin outside the housing, and configured to apply tension to detach the fixing portion from the fixing hole; and
a connecting portion configured to move the fixing portion in a direction opposite to an actuating direction of the actuating pin.

7. The movable partition of claim 6, wherein the fixing portion is configured to fix a plurality of first partitions, comprising the first partition, configured to extend from a plurality of sides of the housing.

8. The movable partition of claim 2, further comprising:
a rail portion located in the first partition, and movable integrally with the first partition along a protrusion in the housing,
wherein the rail portion is configured to move along the protrusion to extend or retract the first partition from the housing.

9. The movable partition of claim 3, further comprising:
a rotary member rotatable along an inside of the first plate;
a first link inside the housing and fastened to the rotary member; and
a second link located in the second plate, facing the first plate and fastened to the rotary member,
wherein the rotary member is configured to rotate so that the first plate moves in a direction to extend from the first link out of the housing, and the second link moves in the direction such that the second plate extends from the first plate.

10. The movable partition of claim 2, wherein the second partition comprises at least one roll blinder configured to extend from the housing at a predetermined angle relative to the first partition.

11. The movable partition of claim 10, wherein the second partition comprises at least two roll blinders, wherein one of the at least two roll blinders is in an upper end of the housing and another of the at least two roll blinders is in a lower end of the housing.

12. The movable partition of claim 10, further comprising:
a fastener configured to fix an end of the second partition to a vehicle body.

13. The movable partition of claim 10, wherein the second partition comprising the at least one roll blinder is configured to move vertically along a groove of the housing.

14. The movable partition of claim 1, wherein the housing comprises:
an upper housing comprising the partition unit; and
a lower housing connected to a lower end of the upper housing and configured to move along a transfer unit on a floor,
wherein the upper housing is configured to be rotatable with respect to the lower housing.

15. The movable partition of claim 14, wherein the transfer unit comprises:
a sliding rail in the floor;
a T-shaped bracket on a rear surface of the lower housing and configured to be inserted into the sliding rail; and
a lever portion configured to rotatably insert the T-shaped bracket into the sliding rail.

16. The movable partition of claim 15, further comprising:
a wire portion located inside the sliding rail and configured to conduct electricity via the T-shaped bracket.

17. The movable partition of claim 3, further comprising:
a handle portion at an outermost portion of the second plate from the housing; and
a roller portion in the second plate and configured to moving along the first plate,
wherein the handle portion is inside the roller portion, and is configured to press an inside of the roller portion in response to rotation of the handle portion.

18. The movable partition of claim 17, wherein the first plate comprises a collet located in the roller portion and facing the second plate, and one end of the handle portion is inside the collet so that the collet is opened in response to the rotation of the handle portion.

19. The movable partition of claim 2, wherein at least one of the first partition or the second partition comprises a display unit.
